(19) United States
(12) Patent Application Publication
(10) Pub. No.: US 2015/0301406 A1
(43) Pub. Date: Oct. 22, 2015

(54) Dimming Unit, Backlight Module Group and Display Device

(71) Applicants: BOE TECHNOLOGY GROUP CO., LTD., Beijing (CN); BEIJING BOE DISPLAY TECHNOLOGY CO., LTD., Beijing (CN)

(72) Inventors: Hongyu ZHAO, Beijing (CN); Dan WANG, Beijing (CN); Seungmin LEE, Beijing (CN); Bin ZOU, Beijing (CN); Xiang LI, Beijing (CN); Junjie GUO, Beijing (CN); Jinku LV, Beijing (CN)

(21) Appl. No.: 14/317,091

(22) Filed: Jun. 27, 2014

(30) Foreign Application Priority Data
Apr. 17, 2014 (CN) 201410156190.6

(51) Int. Cl. G02F 1/1335

(52) U.S. Cl. CPC G02F 1/133611; G02F 1/133605; G02F 1/133606

(57) ABSTRACT

A dimming unit, a backlight module group and a display device are disclosed in the disclosure. The dimming unit according to the disclosure includes a dimming body and a light source, a groove is provided on the dimming body, a cavity is provided on a first sidewall of the groove for accommodating the light source, and the cavity has a light outlet facing a second sidewall of the groove which is opposite to the first sidewall, so that a light ray is reflected by the second sidewall towards an opening of the groove. A backlight module group includes an optical film layer and a light source device provided on a side of a light incident surface of the optical film layer, the light source device includes the dimming unit according to the disclosure, and a light ray emitted by the dimming unit is emitted to the optical film layer.

### CROSS REFERENCE OF RELATED APPLICATIONS

The present application is based on and claims the benefit of priority of Chinese Patent Application No. 201410156190.6 filed on Apr. 17, 2014, the entire contents of which are hereby incorporated by reference.

### TECHNICAL FIELD

The present disclosure relates to the field of display technology, and in particular to a dimming unit, a backlight module group and a display device.

### BACKGROUND

A backlight module group is one of important components of a liquid crystal display. Since the liquid crystal itself dose not emit light, the backlight module group needs to provide the liquid crystal display with adequate bright and light rays distributed evenly, so that images can be displayed on the liquid crystal display normally. Presently, the display technique for the liquid crystal display is becoming mature, and the design of the backlight module group has especially been developed significantly. In addition to the liquid crystal display device such as the liquid crystal display and the liquid crystal television, the backlight module can be adapted to provide light source for the display devices such as a digital photo frame, an electronic paper and a mobile phone.

Depending on the position of the light source group, the backlight module group is classified into an edge-lit backlight module group and a direct-lit backlight module group.

The direct-lit backlight module group is generally applied in a large-size display. In a common direct-lit backlight module group, a plurality of LEDs arranged closely or LEDs with lens are adopted as the light source, since the propagating of the light rays from which is not controlled within a light mixing chamber of the backlight module group, and some of the light rays are often propagated to other regions directly or by reflecting, therefore, the light emitting effect is affected. Further, either in the solution in which the plurality of LEDs are arranged, or in the solution in which the secondary lens is used, both the projections of the light ray are circle-shaped, since the projections of the adjacent LEDs on the diffusion plate cannot be mixed, the uneven of brightness often occurs on the diffusion plate, and thereby the quality of the display is reduced greatly.

### SUMMARY

An object of the present disclosure is to provide a dimming unit, a backlight module group and a display device for effectively solving the crosstalk problem with better light emitting effects.

The dimming unit according the disclosure includes a dimming body and a light source, wherein a groove is provided on the dimming body, a cavity is provided on a first sidewall of the groove for accommodating the light source, and the cavity has a light outlet facing a second sidewall of the groove which is opposite to the first sidewall, so that a light ray is reflected by the second sidewall towards an opening of the groove.

In the dimming unit according to the disclosure, the dimming body is cuboid-shaped, the groove is provided on a first plane of the dimming body, and the groove extends axially from a first side of the first plane to a second side of the first plane which is opposite to the first side.

In the dimming unit according to the disclosure, the first plane comprises a third side and a fourth side which is opposite to the third side, and the first sidewall of the groove is corresponding to the third side, and the second sidewall of the groove is corresponding to the fourth side.

In the dimming unit according to the disclosure, a straight-line distance h between a bottom of the groove and the third side is less than a straight-line distance H between the bottom of the groove and the fourth side.

In the dimming unit according to the disclosure, a surface of the first sidewall of the groove and a surface of the second sidewall of the groove, each is a curved surface, and the surface of the first sidewall of the groove has a greater curvature than that of the surface of the second sidewall of the groove.

In the dimming unit according to the disclosure, the surface of the first sidewall of the groove and the surface of the second sidewall of the groove each is coated with a diffuse reflection coating layer, and the surfaces are manufactured by plastic molding or metal stamping.

The backlight module group according to the disclosure includes an optical film layer and a light source device provided on a side of a light incident surface of the optical film layer, wherein the light source device includes the dimming unit according to the disclosure, and a light ray emitted by the dimming unit is emitted to the optical film layer.

In the backlight module group according to the disclosure, the light source device comprises a plurality of dimming units arranged in parallel, and each opening of groove of the plurality of dimming units faces the optical film layer, and the plurality of dimming units are integrated as a whole by adhering or splicing.

The display device according to the disclosure comprises the backlight module group according to the disclosure.

With the technical solution of the disclosure, the light rays are constrained within the dimming body using the groove, almost without affecting the region where is not corresponding to the opening of the groove, and thus the crosstalk problem is solved effectively.

The shape of the emitting light of the dimming unit according to the disclosure is rectangle, and by defining the brightness level of the light source within the backlight module group, the evenness of the image by the display device can be improved effectively.

### BRIEF DESCRIPTION OF THE DRAWINGS

FIG. 1 is a schematic diagram of a backlight module group according to the disclosure, which shows a structure of a dimming unit according to the disclosure;

FIG. 2 is a perspective schematic diagram of a dimming unit according to the disclosure; and

FIG. 3 is a top view of a schematic diagram of a light source device of a backlight module group according to the disclosure.

### DETAILED DESCRIPTION

The present disclosure will be further described hereinafter in conjunction with the drawings and the embodiments, so that the disclosure can be better understood and embodied by those skilled in the art, but the recited embodiments are not meant to limit the present disclosure.

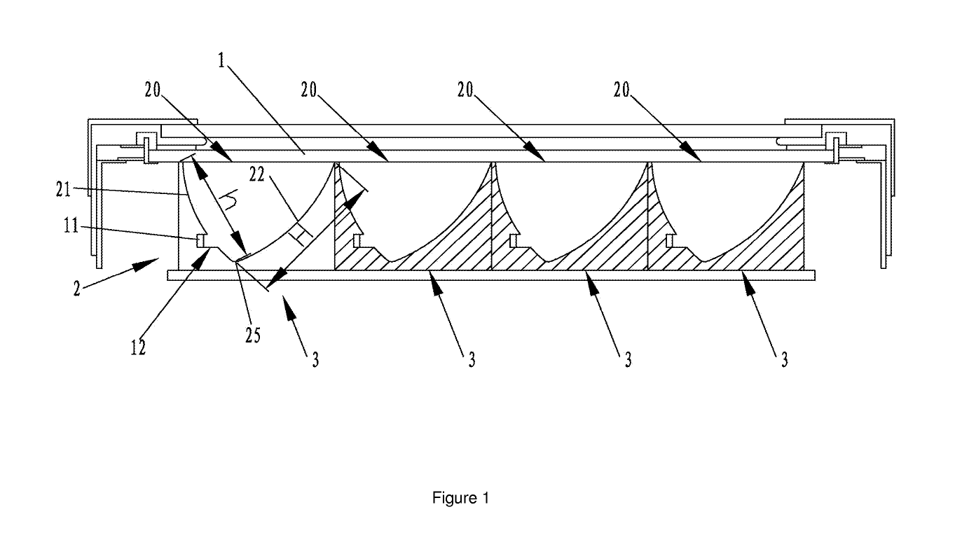

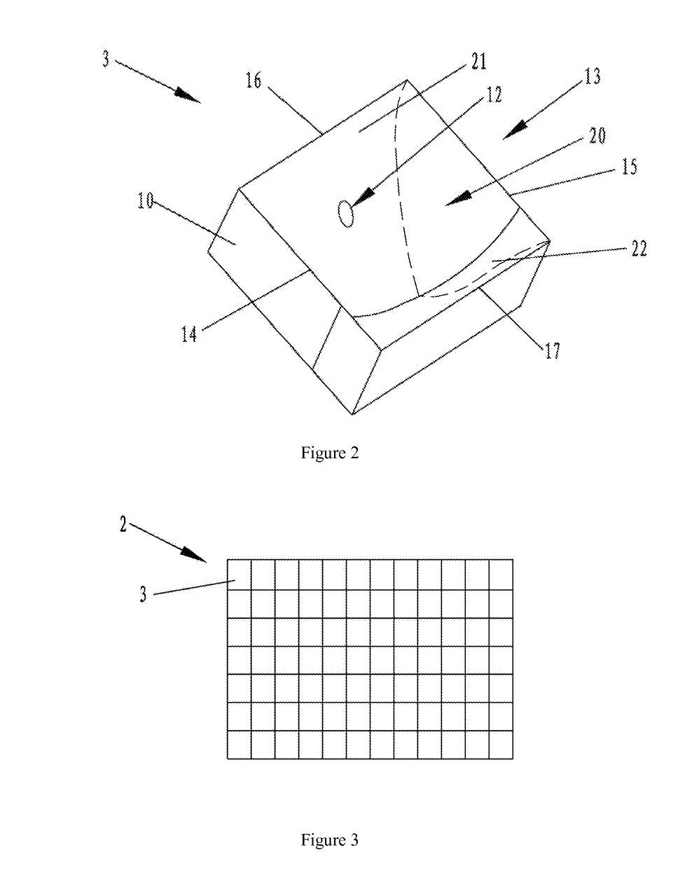

As shown in FIG. 1 and FIG. 2, the dimming unit 3 according to the disclosure includes a dimming body 10 and a light source 11, wherein a groove 20 is provided on the dimming body 10, as shown in FIG. 1, a cross section view of a the groove 20 can be seen, the groove 20 is formed by a first sidewall 21 and a second sidewall 22 oppositely. A cavity 12 is provided on the first sidewall 21 of the groove 20 for accommodating the light source 11, and the cavity 12 has a light outlet facing a second sidewall 22 of the groove 20 which is opposite to the first sidewall 21, so that a light ray is reflected by the second sidewall 22 towards an opening of the groove 20.

With the technical solution of the disclosure, the light rays are constrained within the dimming body using the groove, without affecting a region where is not corresponding to the opening, and thus the crosstalk problem is solved effectively.

In the dimming unit 3 according to the disclosure, the light source 11 is an LED light.

In the dimming unit 3 according to the disclosure, the dimming body 10 is cuboid-shaped, the groove 20 is recessed downwards on a first plane 13 of the dimming body 10, the first plane 13 has a first side 14 and a second side 15 that formed oppositely to each other, and the groove 20 axially extends from the first side 14 of the first plane 13 to the second side 15 of the first plane 13.

In other embodiments of the dimming unit according to the disclosure, the groove also has a third sidewall and a fourth sidewall that formed oppositely to each other, and the third sidewall of the groove connects the first sidewall and the second sidewall, the fourth sidewall of the groove connects the first sidewall and the second sidewall, i.e., the groove is surrounded by the first sidewall, the second sidewall, the third sidewall and the fourth sidewall. And a smooth connection is provided between the first sidewall and the second sidewall, between the second sidewall and the third sidewall, between the third sidewall and the fourth sidewall, and between the fourth sidewall and the first sidewall. A cavity is provided on the first sidewall of the groove for accommodating the light source, and the cavity has a light outlet facing the second sidewall of the groove which is opposite to the first sidewall, so that a light ray is reflected by the second sidewall towards an opening of the groove. Meanwhile, some light rays are reflected to the opening of the groove by the first sidewall, the third sidewall and the fourth sidewall as well.

The shape of the emitting light emitted by the dimming unit of the disclosure is rectangle, and by defining the brightness level of the light source within the backlight module, the evenness of the image by the display device can be improved effectively.

In the dimming unit 3 according to the disclosure, the first plane 13 further includes a third side 16 and a fourth side 17 which is opposite to the third side 16, the groove 20 includes the first sidewall 21 and the second sidewall 22 which is opposite to the first sidewall 21, the first sidewall 21 of the groove 20 is corresponding to the third side 16, and the second sidewall 22 of the groove 20 is corresponding to the fourth side 17, i.e, the first sidewall 21 is approximately in parallel with the third side 16 and close to the third side 16, and the second sidewall 22 is approximately in parallel with the fourth side 17 and close to the fourth side 17. The first sidewall 21 and the second sidewall 22 are jointed together at the bottom of dimming unit 3 to form the bottom 25 of the groove.

The third side 16 and the fourth side 17 each is in parallel with the axial extension direction of the groove 20.

In the dimming unit 3 according to the disclosure, a straight-line distance h between the bottom 25 of the groove 20 and the third side 16 is less than a straight-line distance H between the bottom 25 of the groove 20 and the fourth side 17.

In the dimming unit 3 according to the disclosure, a surface of the first sidewall 21 of the groove 20 and a surface of the second sidewall 22 of the groove 20 each is a curved surface, and the surface of the first sidewall 21 of the groove 20 has a greater curvature than that of the surface of the second sidewall 22 of the groove 20.

In the dimming unit 3 according to the disclosure, an intersecting line between the first sidewall 21 and the first plane 13 is an arc line which is close to the third side 16 and protrudes toward the third side 16; and an intersecting line between the second sidewall 22 and the first plane 13 is an arc line which is close to the fourth side 17 and protrudes toward the fourth side 17.

In the dimming unit 3 according to the disclosure, a surface of the first sidewall of the groove and a surface of the second sidewall of the groove each is coated with a diffuse reflection coating layer, for reflecting the light rays to the opening of the groove 20.

The backlight module group according to the disclosure includes an optical film layer 1 and a light source device 2 provided on a side of a light incident surface of the optical film layer 1, wherein the light source device 2 includes the dimming unit 3 according to the disclosure, and a light ray emitted by the dimming unit 3 is emitted to the optical film layer 1.

In conjunction with FIG. 3, in the backlight module group according to the disclosure, the light source device 2 includes a plurality of dimming units 3 arranged in parallel, and each of the plurality of dimming units 3 has a groove 20 having an opening facing the optical film layer 1.

The display device according to the disclosure includes the backlight module group according to the disclosure.

In the dimming unit according to the disclosure, a reflection curved surface design rather than the secondary lens solution, which is widely used currently, is adopted, and with the side surface, the light rays incident from the other side surface is reflected for multiple times and is equalized.

With the dimming unit according to the disclosure, the light rays are constrained within the dimming body 10, without affecting the un-corresponding region, and thus the crosstalk problem in regional dimming is solved effectively. Meanwhile, the shape of the emitted light emitting from the dimming unit of the disclosure is rectangle, and by defining the brightness level of the light source 11, the evenness of the image by the display device can be improved effectively.

In the dimming unit according to the disclosure, the variation curvature of the surfaces of the sidewall of the groove and the size of the dimming body can be adjusted as practical needs, for achieving the thinning of the backlight module group or reducing the cost thereof.

In the dimming unit according to the disclosure, each of the surface of the first sidewall 21 of the groove 20 and the surface of the second sidewall 22 of the groove 20 is a curved surface, which can be molded by plastic molding, or can also be formed by metal stamping.

In the backplate of the backlight module group according to the disclosure, a plurality of dimming units according to the disclosure are arranged, for forming a light-emitting array. The plurality of dimming units according to the disclosure can be integrated as a whole by adhering or splicing (such as tongue and groove-splicing). The light source of each of the plurality of dimming units according to the disclosure is controlled to be on and off by a circuit board.

In the backlight module group according to the disclosure, an optical film layer such as a diffusion plate and a film piece is provided and adhered on top of the dimming unit, for achieving the configuration of the whole backlight module.

In the backlight module group according to the disclosure, the backplate serves as a carrying component of the dimming unit, a plurality of dimming units are arranged on the backplate in an array, a optical film layer such as the diffusion plate and the film piece is spreaded and adhered on the top of the dimming unit, a liquid crystal panel is covered above the optical film layer, and is fixed using the metal frame, for achieving the assembly of the display device according to the disclosure.

The display device according to the disclosure may be any product or component with display function such as an electronic paper, a liquid crystal television, a liquid crystal display, a digital photo frame, a mobile phone and a tablet computer, etc.

Due to being arranged with the dimming unit according to the disclosure, the quality of the backlight module group according to the disclosure is further-improved.

Due to being arranged with the backlight module group according to the disclosure, the quality of the display device according to the disclosure is further-improved.

The above are only preferred embodiments of the disclosure. It should be noted that several modifications and alternations can be made to the embodiments by those skilled in the art without deviating from the principle of the disclosure, whereas the modifications and alternations should be deemed as within the scope of protection of the disclosure.

What is claimed is:

1. A dimming unit, comprising a dimming body and a light source, a groove is provided on the dimming body, a cavity is provided on a first sidewall of the groove for accommodating the light source, and the cavity has a light outlet facing a second sidewall of the groove which is opposite to the first sidewall, so that a light ray is reflected by the second sidewall towards an opening of the groove.

2. The dimming unit according to claim 1, wherein the dimming body is cuboid-shaped, the groove is provided on a first plane of the dimming body, and the groove extends axially from a first side of the first plane to a second side of the first plane which is opposite to the first side.

3. The dimming unit according to claim 2, wherein the first plane comprises a third side and a fourth side which is opposite to the third side, the first sidewall of the groove is corresponding to the third side, and the second sidewall of the groove is corresponding to the fourth side.

4. The dimming unit according to claim 3, wherein a straight-line distance h between a bottom of the groove and the third side is less than a straight-line distance H between the bottom of the groove and the fourth side.

5. The dimming unit according to claim 1, wherein each of a surface of the first sidewall of the groove and a surface of the second sidewall of the groove is a curved surface, and the surface of the first sidewall of the groove has a curvature greater than that the surface of the second sidewall of the groove.

6. The dimming unit according to claim 1, wherein each of the surface of the first sidewall of the groove and the surface of the second sidewall of the groove is coated with a diffuse reflection coating layer.

7. The dimming unit according to claim 1, wherein the surfaces are formed by plastic molding or metal stamping.

8. A backlight module group, comprising an optical film layer and a light source device provided on a side of a light incident surface of the optical film layer, the light source device comprises the dimming unit according to claim 1, and a light ray emitted by the dimming unit is emitted to the optical film layer.

9. The backlight module group according to claim 8, wherein the dimming body is cuboid-shaped, the groove is provided on a first plane of the dimming body, and the groove extends axially from a first side of the first plane to a second side of the first plane which is opposite to the first side.

10. The backlight module group according to claim 9, wherein the first plane comprises a third side and a fourth side which is opposite to the third side, the first sidewall of the groove is corresponding to the third side, and the second sidewall of the groove is corresponding to the fourth side.

11. The backlight module group according to claim 10, wherein a straight-line distance h between a bottom of the groove and the third side is less than a straight-line distance H between the bottom of the groove and the fourth side.

12. The backlight module group according to claim 8, wherein each of a surface of the first sidewall of the groove and a surface of the second sidewall of the groove is a curved surface, and the surface of the first sidewall of the groove has a curvature greater than that the surface of the second sidewall of the groove.

13. The backlight module group according to claim 8, wherein each of the surface of the first sidewall of the groove and the surface of the second sidewall of the groove is coated with a diffuse reflection coating layer.

14. The backlight module group according to claim 8, wherein the surfaces are formed by plastic molding or metal stamping.

15. The backlight module group according to claim 8, wherein the light source device comprises a plurality of dimming units arranged in parallel, and each of the plurality of dimming units has a groove with an opening facing the optical film layer.

16. The backlight module group according to claim 15, wherein the plurality of dimming units are integrated as a whole by adhering or splicing.

17. A display device, comprising the backlight module group according to claim 8.

18. The display device according to claim 17, wherein the light source in the display device comprises a plurality of dimming units arranged in parallel, and each of the plurality of dimming units has a groove with an opening facing the optical film layer.

19. The display device according to claim 17, wherein the dimming units are integrated as a whole by adhering or splicing.
